(19) United States
(12) Patent Application Publication
(10) Pub. No.: US 2017/0110028 A1
(43) Pub. Date: Apr. 20, 2017

(54) Create A Meal Mobile Application

(71) Applicant: Davenia M. Poe-Golding, Brooklyn, NY (US)

(72) Inventor: Davenia M. Poe-Golding, Brooklyn, NY (US)

(21) Appl. No.: 14/887,518

(22) Filed: Oct. 20, 2015

(51) Int. Cl. G09B 19/00; G09B 5/12; H04L 29/08

(52) U.S. Cl. CPC G09B 19/0092; H04L 67/02; G09B 5/125

(57) ABSTRACT

The invention discloses a system and method for assisting a user in assembling a meal combination according to available ingredients. The system is comprised of a personal computing device configured to communicate. The system displays information according to the available ingredients of the meals. This invention is a search engine, linked to the Internet, and includes a prompt for a user to submit at least one prompt for available ingredient information.

### CROSS REFERENCE TO RELATED APPLICATIONS

Not applicable.

### FEDERALLY SPONSORED RESEARCH AND DEVELOPMENT

Not applicable.

### MICROFICHE

Not applicable.

### BACKGROUND OF THE INVENTION

1. Field of the Invention

The present invention relates to web-based computer implemented applications. The invention particularly relates to a web-based computer implemented application that allows the user to search for a recipe available for a set of ingredients, and then gives results of what one could possibly cook.

2. Background of the Invention

Conventionally, cooking recipes are provided in the form of printed matters, such as cooking recipe books, and usually homemakers decided a menu of dinner, etc. from the cooking recipe books. Then, food materials for meals (menu) were purchased in accordance with the cooking recipe.

In the prior art, many people rely on cookbooks that have recipes and instructions to prepare the individual courses of a meal, such as main dishes, side dishes, salads, desserts, and other courses. Over time, particularly with the advent of the Internet, more sources of recipes, meal preparation, and cooking information have become available. Currently, many web platforms, such as websites, web applications, and mobile applications (Apps), are designed to provide information that is related to cooking methods with certain food ingredients.

Many people who prepare food, particularly amateurs or average homemakers, face various challenges when preparing meals. For example, the time required for preparing foods by an average or beginner cook is often underestimated, and the amount of actual time spent preparing and cooking a meal is often longer than estimated. Therefore, the time that is available to prepare a meal is too short. This is often the case because of lack of time that is needed to prepare a plurality of recipes, for example, in a multi-course meal is not consolidated and/or coordinated in a cookbook. Therefore, the total or accumulated time needed to prepare a meal is not adequately estimated or factored in cookbooks, Internet websites, or other providers of recipes.

U.S. Pat. No. 7,039,589, issued May 2, 2006 to Whitham, is an interactive multimedia book. That device, however, is limited to the extent that the invention does not allow personalization of criteria for determination of what recipes are chosen; the user is limited to a search of existing recipes based upon keywords for the end food product. Furthermore, the device does not provide means for determining available recipes based on certain starting ingredients or alternative ingredients, nor information regarding particular dietary choices or constraints.

U.S. Pat. No. 7,092,988, issued to Bogatin on Aug. 15, 2006, publishes a rapid cooking oven with broadband communication capability. The oven has an integrated programmable controller that utilizes a number of cooking programs to control cooking phases, specifically heat and time parameters for food placed within the oven. That invention also teaches that the oven includes an integrated wireless system to allow access to digital content. The Bogatin invention, however, does not provide the capability for interaction between the user and the device to alter recipes. The invention focuses primarily on controlling a stationary cooking source, a high speed oven, wherein the device provides cooking times a control for a set recipe.

What is needed, therefore, is a system of providing interactive recipe and cooking information that is tailored to the particular needs and tastes of a user. In particular, there is a need for a system that provides interactive choices regarding particular types and styles of food preparation in accordance with a user's choice, medical and/or dietary requirements, or a set of particular ingredients that a user has as a starting point for recipe choices. The system should provide an interactive database of cooking and recipe information that allows a user to tailor searches and recipes based on a set of personalized criteria. The system should also provide means for updating and amending the system's cooking information database via external sources, such as World Wide Web support through various means, including wired and wireless connection. Furthermore, the system should provide for voice interaction, similar to ‘Siri’ for iPhone users, so that the user may work in the kitchen without having to physically touch the device, freeing the user's hands for the tasks involved in cooking.

The system will provide the user quick and modifiable information for cooking, such that unskilled individuals can cook tasty and complex meals with little training or experience. The system will provide simple instructions, and allow a user to search for and utilize one or more recipes simultaneously, where those recipes are selected from a recipe database based upon certain user-identified cooking and dietary preferences and/or limitations.

### SUMMARY OF THE INVENTION

In the view of the foregoing disadvantages inherent in the known types of web-based computer implemented applications for finding recipes now present in the prior art, the present invention provides an improved web-based computer implemented system and method for finding recipes for available ingredients. As such, the general purpose of the present invention, which will be described subsequently in greater detail, is to provide a new and improved application that has all of the advantages of the prior art, and none of the disadvantages.

The present invention is directed to an application, system, and method for electronically obtaining meal information based on available ingredients.

It is an objective of the present invention to provide a search engine linked to the Internet that includes a prompt for a user to submit at least one prompt for available ingredient information. Based on the search, recipe information is generated by a selection of at least some of the stored electronic meal information that corresponds with the available ingredients.

The method of this invention includes an option for a user to make whatever they desire, and, accordingly, give style, shape and texture.

The main advantage of the present invention is that invention also benefits those people who have experienced not having a certain ingredient or just simply not having the money to buy additional ingredients and want to cook something with what they already have.

Other features and advantages of the present invention will become more apparent from the following detailed description when taken in conjunction with the accompanying drawings which illustrate, by way of example, the principles of the invention.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

The invention will be better understood, and objectives other than those set forth above will become apparent, when consideration is given to the following detailed description thereof. Such description makes reference to the annexed drawings wherein:

FIG. 1 depicts a list of food to be search with the information system acts as a search engine, like Google.

FIG. 2 depicts the search result for the ingredients.

### DETAILED DESCRIPTION OF THE INVENTION

The following detailed description refers to the accompanying drawings that illustrate the embodiments of the present invention. These embodiments are described in sufficient detail to enable those skilled in the art to practice the invention. Other embodiments are possible, and modifications may be made to the embodiments without departing from the spirit and scope of the invention. Therefore, the following detailed description is not meant to limit the invention. Rather, the scope of the invention is defined by the appended claims.

Mobile endpoint device use has increased in popularity in the past few years. Associated with the smart phones, Tablet, computer endpoint devices are the proliferation of software applications (broadly known as “apps” or “applications”) that are created for the computational endpoint devices. A mobile app is a software application developed specifically for use on small, wireless computing devices, such as smartphones and tablets, rather than desktop or laptop computers. Everybody cooks, shops, and find recipes differently, but most people have the same end in mind: tasty homemade food with as few headaches as possible.

The current invention is directed to a software application for Smart phones, Tablet, Computer, or any other PDA and method for electronically obtaining meal information based on available ingredients.

The disclosed information system for recipes allows the user to search a set of random meals, and the software application then gives ideas of what one could possibly cook. The method, which may be stored in a non-stationary computer readable medium, may have the storage capacity of 2-50 megabytes.

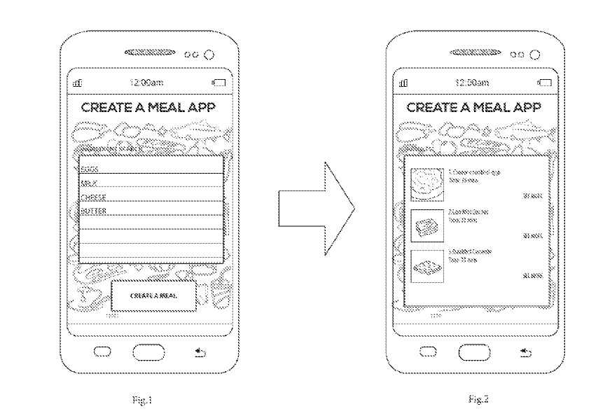

This information system acts as a search engine, like Google, which allows instant access to recipes that are present online FIG. 1. Using the data received from users, the information processor executes electronic instructions to match the user-provided parameters with recipe information stored in the one or more databases FIG. 2. Once the user types the entire ingredient they have, the search will give them a list of the style of food they can cook.

The system could even be able to break down the style of food, based on one of the food items from the list, then the user will get a chance to decide. That would encourage the people to click on items if they are in a rush.

The main advantage of the present invention is that the people who have no experience with certain ingredients, or who simply do not have the money to buy additional ingredients, can cook something with the ingredients that they already have. It will benefit to the food companies and the public in general.

It is to be understood that the above description is intended to be illustrative, and not restrictive. For example, the above-discussed embodiments may be used in combination with each other. Many other embodiments will be apparent to those of skill in the art upon reviewing the above description. It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations, or structures described herein as a single instance. Finally, boundaries between various components are somewhat arbitrary, and particular operations are illustrated in the context of specific illustrative configurations. Other allocations of functionality are envisioned, and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

The benefits and advantages that may be provided by the present invention have been described above with regard to specific embodiments. These benefits and advantages, and any elements or limitations that may cause them to occur or to become more pronounced, are not to be construed as critical, required, or essential features of any or all of the embodiments.

While the present invention has been described with reference to particular embodiments, it should be understood that the embodiments are illustrative, and that the scope of the invention is not limited to these embodiments. Many variations, modifications, additions, and improvements to the embodiments described above are possible. It is contemplated that these variations, modifications, additions, and improvements fall within the scope of the invention.

What is claimed is:

1. A web-based computer implemented system for suggesting a recipe to a user, the system comprising:
a personal computing device, utilized by the user, connected to a network;
an application program running on a central processing unit;
a programmable controller for executing program instructions;
memory media for recording executable program instructions; and
a display for displaying text and video clips.

2. The system according to claim 1, wherein the personalized computing device is a smartphone or like.

3. The system according to claim 1, wherein the application program running on a central processing unit allows the user to input data to receive a suitable recipe.

4. The system according to claim 3, wherein the input data includes a set of instructions.

5. The system according to claim 3, wherein the set of instructions includes a list of available ingredients with the user.

6. The system according to claim 1, wherein the programmable controller for executing program instructions operates collaboratively with said network to define a broadband communication system which allows a bidirectional communication of digital data content between the personal computing device and resources available online.

7. The system according to claim 6, wherein the resources available online include HTML files, PDF files, word documents, and flash content.

8. The system according to claim 1, wherein the display of the personalized computing device displays the digital content being exchanged between the device and resources available online to the user.

9. The system according to claim 8, wherein the digital content displayed to the user is in form of a text or a video clip.

10. A web-based computer implemented method for suggesting a recipe to a user, the method comprising :
establishing an electronic connection between a personal computing device of a user and a network;
running an application program on a central processing unit of the personal computing device;
entering a meal-related criterion about an ingredient, a cuisine or a recipe;
receiving from a user preference data;
developing a meal for said user comprising food items from database consistent with said user ingredient preference;
generating a meal suggestion message comprising a food suggestion based on said ingredient;

11. The method according to claim 10, wherein the application program is a website linked to the Internet and all food networks.

12. The method according to claim 11, wherein the website enables the user to input a list of ingredients available.

13. The method according to claim 10 or 12, wherein the website provides suggestion message displaying suitable recipes available on internet network according to the list of ingredients input by user.
